(19) United States
(12) Patent Application Publication
(10) Pub. No.: US 2008/0114582 A1
(43) Pub. Date: May 15, 2008

(54) DETECTING TAMPERING OF A SIGNAL

(75) Inventors: Guillaume LETERRIER, Biot (FR); Osman KOYUNCU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/930,755

(22) Filed: Oct. 31, 2007

(30) Foreign Application Priority Data
Nov. 10, 2006 (EP) 06291756.2

(51) Int. Cl. G06F 11/273

(52) U.S. Cl. 703/28

(57) ABSTRACT

Systems and methods for detecting tampering of a signal are described herein. Some illustrative embodiments include an integrated circuit including an input/output (I/O) pad (electrically accessible from outside the integrated circuit), an I/O circuit coupled to the I/O pad that receives an internally generated signal and causes the internally generated signal to be propagated to the I/O pad, and a comparator having first and second input nodes (the first input node configured to receive a digital representation of the internally generated signal, and the second input node coupled to the I/O pad and configured to receive a digital representation of a signal present at the I/O pad). The comparator signals an exception condition if a logic level of a bit of the digital representation of the internally generated signal does not match a logic level of a bit of the digital representation of the signal present at the I/O pad.

### CROSS-REFERENCE TO RELATED APPLICATIONS

This application is a non-provisional application claiming priority to European Patent Office Application Serial No. EP 06291756.2, filed on Nov. 10, 2006, and entitled “Secure Output Digital Signal,” which is hereby incorporated by reference.

### BACKGROUND

As more and more circuits and functionality are being integrated into semiconductor chips, fewer signals are accessible outside of the chips, due at least in part to the decreased number of components and interconnecting signals. Nonetheless, despite great strides that have been made towards the goal of a true “system on a chip,” most fully functional electronic systems include several chips and other electronic components that are mounted on, and interconnected by, an electronic circuit board or other similar structure. As a result, at least some signals input to, and/or output by, a semiconductor chip are accessible from outside the chip and may thus be vulnerable to tampering.

A malicious user may tamper with a signal that is output by a chip, for example, by coupling a high-capacity driver to a signal trace externally coupled to the chip, forcing the logic level of the signal to a state opposite that being output by the on-chip driver. The high-capacity driver achieves this by having the capacity to sink or source current well in excess of the maximum capacity of the on-chip driver, allowing the high-capacity driver to raise or lower the voltage on the signal line to the level necessary to force the opposite logic state. By overriding signals from a semiconductor chip in this manner, a malicious user can fool other components within the system into operating in modes that might not otherwise be accessible. Thus, for example, a malicious user might be able to override one or more output signals generated by a processor so as to fool a secure memory chip into transitioning into a secure mode of operation and causing the chip to output a decryption key. Analog signals output by a chip may also be similarly overridden.

Similarly, a malicious user can also tamper with input signals that are present at an input pin of a chip, but that are not connected by the designers to outside circuitry and are configured to use internal pull-ups and/or pull-downs to set the levels of the input signals. A malicious user may simply probe the unconnected I/O pin directly on the chip and override these pre-programmed levels in a manner similar to that used to override an output driver.

While it may not be possible to completely prevent unauthorized physical access to, and interference with, the signals and signal traces between chips, as well as the unused pins on chips, it would still be useful to detect and react to an attempted override of signals present at the I/O pins of a semiconductor chip, since an undetected security breach is far more dangerous and potentially damaging than one that is detected, recognized and accounted for.

### SUMMARY

Systems and methods for detecting tampering of a signal are described herein. Some illustrative embodiments include an integrated circuit that includes an input/output (I/O) pad (electrically accessible from outside the integrated circuit), an I/O circuit coupled to the I/O pad that receives an internally generated signal and causes the internally generated signal to be propagated to the I/O pad, and a comparator having first and second input nodes (the first input node configured to receive a digital representation of the internally generated signal, and the second input node coupled to the I/O pad and configured to receive a digital representation of a signal present at the I/O pad). The comparator signals an exception condition if a logic level of a bit of the digital representation of the internally generated signal does not match a logic level of a bit of the digital representation of the signal present at the I/O pad.

Other illustrative embodiments include an on-chip input/output (I/O) circuit that includes a comparator having first and second input nodes, the first input node configured to receive a source signal, and the second input node coupled to an I/O pad and configured to receive a signal present at the I/O pad. The I/O circuit receives the source signal and causes the source signal to be propagated to the I/O pad. An exception condition is signaled by the comparator if the logic level of at least part of a digital representation of the source signal does not match the logic level of at least part of a digital representation of the signal present at the I/O pad.

Yet further illustrative embodiments include a method, including enabling an input/output (I/O) circuit to determine a level of a signal present at an I/O pad based upon a control signal, comparing one or more bits of a digital representation of the control signal to one or more bits of a digital representation of the signal present at the I/O pad, and signaling an exception if a logic level of at least one of the one or more bits of the digital representation of the control signal does not match a level of at least one of the one or more corresponding bits of the digital representation of the signal present at the I/O pad.

### BRIEF DESCRIPTION OF THE DRAWINGS

For a detailed description of illustrative embodiments of the invention, reference will now be made to the accompanying drawings in which:

FIG. 1A shows a simplified diagram of a digital programmable input/output (I/O) circuit, constructed in accordance with at least some illustrative embodiments;

FIG. 1B shows a simplified diagram of an analog programmable input/output (I/O) circuit, constructed in accordance with at least some illustrative embodiments;

FIGS. 2A, 2B and 2C show several examples of how exceptions generated by the digital I/O circuit of FIG. 1A may be utilized to respond to a detected security violation, in accordance with at least some illustrative embodiments;

FIG. 3 shows a simplified diagram of a digital input circuit with programmable pull-up and pull-down elements, constructed in accordance with at least some illustrative embodiments;

FIG. 4A shows a timing diagram reflecting the timing of various signals in FIGS. 4B and 4C, in accordance with at least some illustrative embodiments;

FIG. 4B shows a digital I/O circuit that includes a delay line, constructed in accordance with at least some illustrative embodiments;

FIG. 4C shows a digital I/O circuit that includes a synchronization latch, constructed in accordance with at least some illustrative embodiments;

FIG. 5 shows a method for detecting an attempted tampering of an output signal, in accordance with at least some illustrative embodiments; and

FIG. 6 shows a method for detecting an attempted tampering of an input signal, in accordance with at least some illustrative embodiments.

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more hardware and/or software components and may be used to refer to an electronic device, such as an integrated circuit, a portion of an integrated circuit, a combination of integrated circuits, etc. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

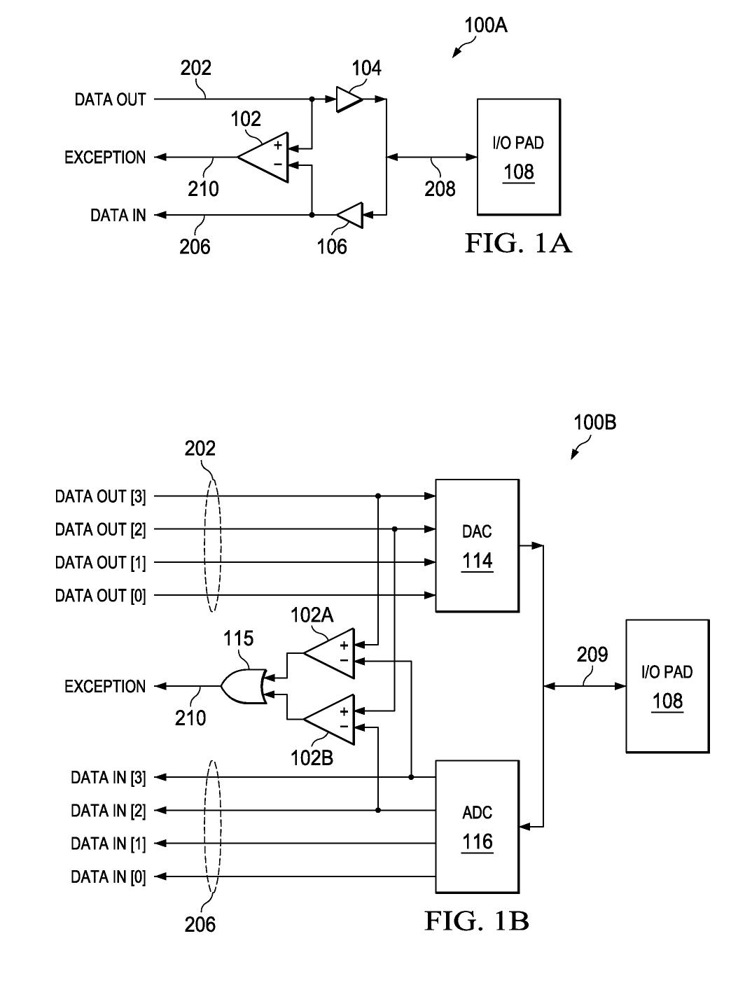

FIG. 1A illustrates a digital input/output (I/O) circuit 100A that includes logic for detecting attempts at overriding the output of the circuit, in accordance with at least some illustrative embodiments. During output operation output driver 104, which couples to I/O pad 108, is enabled and outputs Data Out signal 202 (a source or control signal provided from elsewhere in the semiconductor chip that incorporates I/O circuit 100A) as output signal 208 onto I/O pad 108 (e.g., a bond pad of an integrated circuit). Output driver 104 also serves to isolate Data Out signal 202 from the effects of any attempted tampering present at I/O pad 108. Input buffer 106, also coupled to I/O pad 108, is used to monitor output signal 208 and to provide Data In signal 206 (ignored by other circuitry during output operation of I/O circuit 100A) as a feedback signal to comparator 102. During input operation of I/O circuit 100A, input buffer 106 accepts signals presented at I/O pad 108 from outside the chip that includes I/O circuit 100A, and both output driver 104 and comparator 102 are disabled.

In the illustrative embodiment of FIG. 1A, the output node of input buffer 106 and the input node of output driver 104 are respectively coupled to the negative input node and the positive input node of comparator 102. When I/O circuit 100A is configured for output operation and is operating normally (i.e., not being tampered with), Data In signal 206 will have the same logic level as Data Out signal 202, once Data Out signal 202 has propagated through output driver 104 and input buffer 106. Because the two signals presented at the input nodes of comparator 102 are both at the same digital logic level, exception signal 210 is de-asserted. If, however, a malicious user overdrives the signal present at I/O pad 108 and forces a logic level opposite that being driven by output driver 104, Data In signal 206 will reflect the logic level of the forced signal generated by the malicious user. As a result, Data In signal 206 will not match Data Out signal 202, causing exception signal 210 to be asserted, indicating that the signal being output by output driver 104 is being tampered with.

FIG. 1B illustrates an analog input/output (I/O) circuit 100B that includes logic for detecting attempts at overriding the output of the circuit, in accordance with at least some illustrative embodiments. During output operation, digital-to-analog converter (DAC) 114, which includes an analog output buffer and couples to I/O pad 108, is enabled and outputs an analog representation of Data Out signals 202 as analog output signal 209 onto I/O pad 108 (e.g., a bond pad of an integrated circuit). Data Out signals 202 are a group of digital source and/or control signals provided from elsewhere in the semiconductor chip that incorporates I/O circuit 100B. DAC 114 also serves to isolate the Data Out signals 202 from the effects of any attempted tampering present at I/O pad 108. Analog-to-digital converter (ADC) 116 (which includes an analog input buffer and is also coupled to I/O pad 108) is used to monitor analog output signal 209 and to provide the Data In signals 206 as feedback signals to comparators 102A and 102B. Data In signals 206 are ignored by other circuitry during output operation of I/O circuit 100B. During input operation of analog I/O circuit 100B, ADC 116 accepts analog signals presented at I/O pad 108 from outside the chip that includes I/O circuit 100B, and DAC 114 and comparators 102A and 102B are disabled.

In the illustrative embodiment of FIG. 1B, the two most significant output bits of ADC 116 and the two most significant input bits of DAC 114 are respectively coupled to the negative input nodes and the positive input nodes of comparators 102A and 102B. When I/O circuit 100B is configured for output operation and is operating normally (i.e., not being tampered with), the two most significant bits of the Data In signals 206 will each have the same logic level as the corresponding two most significant bits of the Data Out signals 202, once the Data Out signals 202 have propagated through DAC 114 and ADC 116. Because the signals presented at the input nodes of each of the comparators 102A and 102B are at the same digital logic level, exception signal 210 (the output of OR gate 115 which combines the outputs signals of comparators 102A and 102B) is de-asserted. By not including the two least significant bits of both the Data Out and Data In signals (i.e., the signal generated by DAC 114 and the signal as detected and digitized by ADC 116), the two corresponding analog signals do not have to have identical values, just values that differ by less than a tolerance value (i.e., the range of values represented by the two least significant bits). If, however, a malicious user overdrives the signal present at I/O pad 108 and forces an analog signal level different, the Data In signals 206 will reflect the analog signal level of the forced signal generated by the malicious user. If the difference between the Data Out and Data In signals is greater than the tolerance value, at least one of the two most significant bits of Data In signals 206 will not match the corresponding bit of the two most significant Data Out signals 202. The mismatched bits thus cause exception signal 210 to be asserted, indicating that the signal being output by DAC 114 is being tampered with.

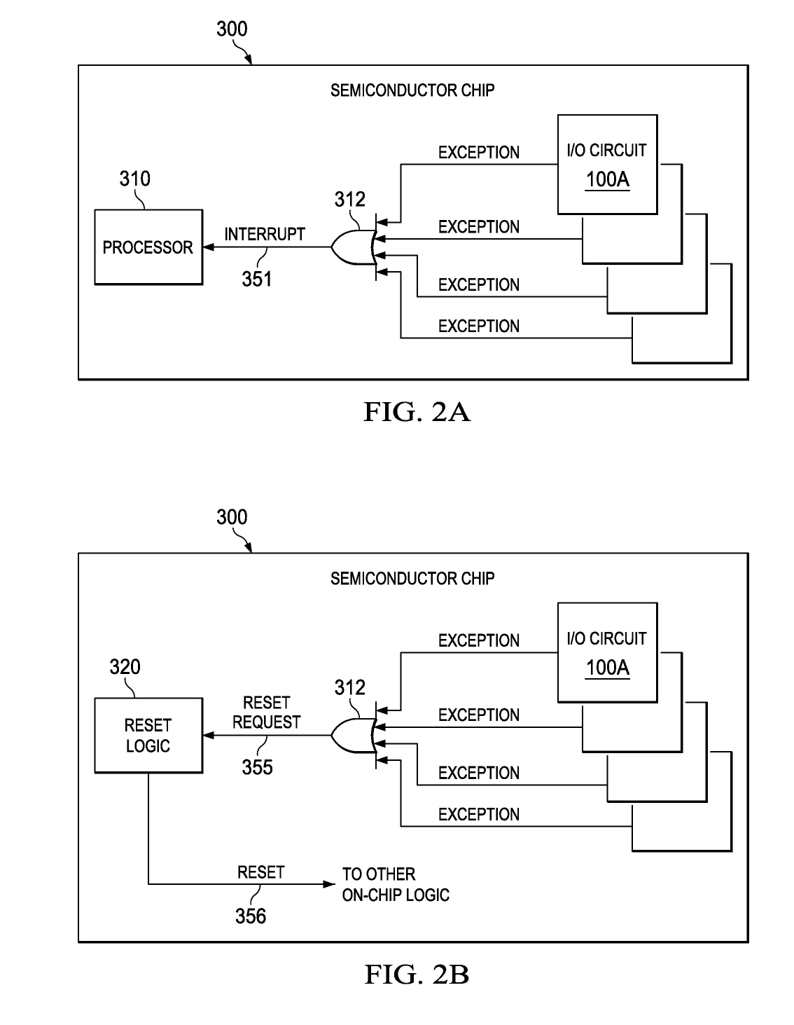

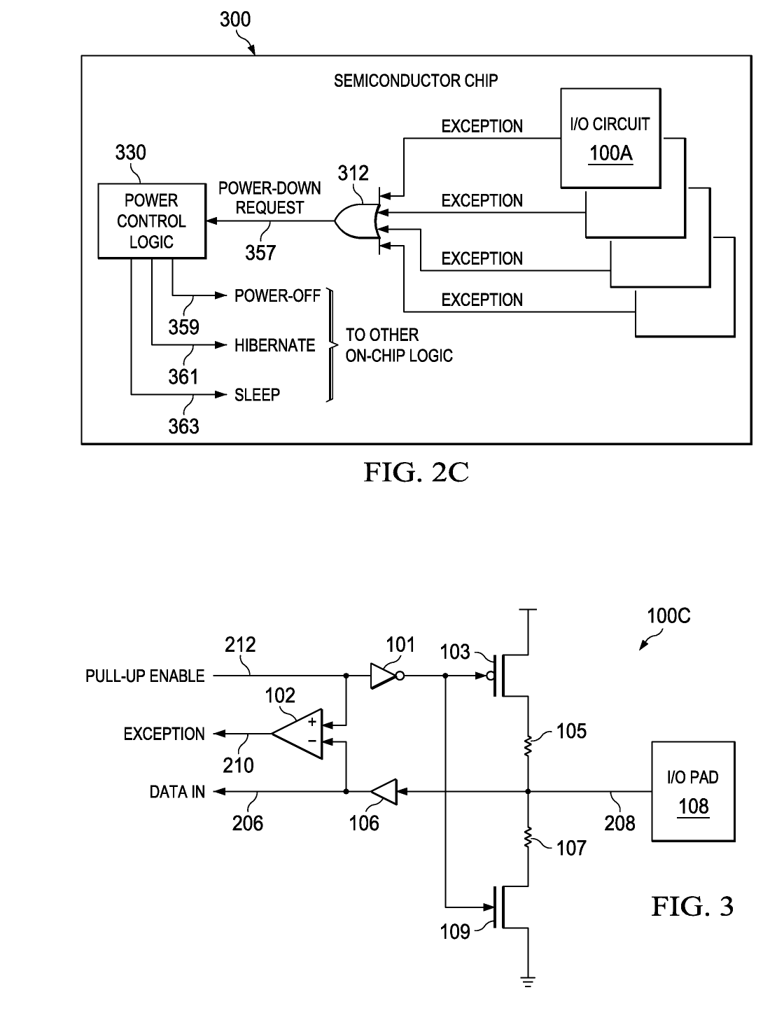

The assertion of exception signal 210 by comparator 102 of FIG. 1A (or by OR gate 115 of FIG. 1B) may thus be used as an indicator of a security violation within a system incorporating a chip using I/O circuit 100A of FIG. 1A (or I/O circuit 100B of FIG. 1B). In at least some illustrative embodiments, exception signal 210 may be used to drive an interrupt signal of a processor. The illustrative embodiment of FIG. 2A shows an example of four I/O circuits 100A, wherein the exception signal output by each I/O circuit each drives an input node of OR gate 312. If an attempt is made to tamper with the output of any of the four I/O circuits 100A, one or more exceptions are asserted, which cause interrupt signal 351 to be asserted by OR gate 312, which couples to processor 310. When interrupt signal 351 is asserted, an interrupt is generated at processor 310 that causes interrupt handler software to execute. The interrupt handler can respond to the security violation thus indicated by taking a variety of actions, such as, for example, isolating, resetting or shutting down part or all of a system that includes the chip incorporating I/O circuit 100A of FIG. 1A, as well as alerting an operator or administrator of the system of the security breach.

In other illustrative embodiments, exception signal 310 may trigger the isolation, reset or shutdown in hardware of a system that includes the I/O circuit 100A, without the intervention of a processor or software executing on a processor. FIG. 2B shows an embodiment wherein the assertion of one or more exception signals cause OR gate 312, which is coupled to reset logic 320, to assert reset request signal 355, which causes reset logic 320 to assert reset signal 356, thereby causing other logic to be reset. Similarly, in the illustrative embodiment of FIG. 2C, the assertion of one or more exception signals cause OR gate 312, which is coupled to power control logic 330, to assert power-down request signal 357, causing one of power signal 359, hibernate signal 361, or sleep signal 363 to be asserted by power control logic 330. In at least some illustrative embodiments, power control logic 330 is pre-programmed (e.g., as part of a Basic Input/Output System (BIOS) configuration of a computer that includes a chip incorporating I/O circuit 100A) to select which of the three power control signal is asserted in response to an assertion of power-down request signal 357. As can be seen from these examples, responses to the assertion of exception signal 210 can be implemented exclusively in hardware to provide a fast response to the exception, or implemented as a combination of hardware and software so as to provide flexibility in the response to the assertion of the exception signal. Other hardware-based embodiments and embodiments using combinations of hardware and/or software that react to the assertion of exception signal 310, as well as other reactions and derived signal, will become apparent to those of ordinary skill in the art, and all such embodiments, combinations, reactions and derived signals are within the scope of the present disclosure.

In other illustrative embodiments, the I/O circuit may be configured for operation as a digital input circuit with optionally enabled pull-up and pull-down structures, as shown in I/O circuit 100C of FIG. 3. Such a configuration can be used to provide a default logic level for a digital input circuit in the absence of a driven input signal, or to allow the input to be configured at a fixed logic level without the need for external components to select the desired logic level of the input. In such configurations, it may not be desirable, under at least some circumstances, to allow the inputs to be driven to logic levels other than the programmed default or fixed logic levels. When so configured, an attempt at changing the logic levels of I/O circuit 100C is treated as an attempted tampering. Comparator 102 of FIG. 3 operates in the same manner as comparator 102 of FIG. 1A to similarly detect such tampering.

Continuing to refer to I/O circuit 100C of FIG. 3, pull-up enable signal 212 (a source or control signal provided from elsewhere in the semiconductor chip that incorporates I/O circuit 100C) determines whether the signal originating at I/O pad 108 will be asserted or de-asserted by default. Pull-up enable signal 212 is inverted by inverter 101, which also isolates pull-up enable signal 212 from the effects of any attempted tampering present at I/O pad 108. The output node of inverter 101 couples to the gates of both pull-up enable device 103 and pull-down enable device 109. Pull-up enable device 103 couples to both the positive supply and pull-up resistive device 105 (e.g., an on-chip resistor), and pull-down enable device 109 couples to ground and pull-down resistive device 107 (e.g., another on-chip resistor). Pull-up resistive device 105 and pull-down resistive device 107 couple to each other, to I/O pad 108, and to the input node of input buffer 106.

When pull-up enable signal 212 is asserted, pull-up enable device 103 is turned on and pull-down enable device 109 is turned off, causing the signal at I/O pad 108 to be driven high through resistive device 105, which in the embodiment shown is treated as an asserted logic level. Similarly, when pull-up enable signal 212 is de-asserted (indicative of a pull-down enable), pull-down enable device 109 is turned on and pull-up enable device 103 is turned off, causing the signal at I/O pad 108 to be driven low through resistive device 107 (a de-asserted logic level in the embodiment shown).

The logic level that results from the enabled pull-up or pull-down device thus reflects the logic level of pull-up enable signal 212. The logic level present at I/O pad 108 is propagated by input buffer 106, the output of which couples to the negative input node of comparator 102 of the illustrative embodiment. Because the input node of inverter 101 is coupled to the positive input node of comparator 102, pull-up enable signal 212 is presented at the positive input node and thus compared against Data In signal 206, which is output by input buffer 106. As long as pull-up enable signal 202 and Data In signal 206 match, exception signal 210 remains de-asserted. If signal 208 at I/O pad 108, however, is driven by an externally generated source to a logic level different from that of pull-up enable signal 212, comparator 102 detects the difference and asserts exception signal 210.

In this manner, if I/O circuit 100C is configured for input operation with a default or fixed input signal level, and proper and/or secure operation of the system requires that this level not be altered, any attempt at tampering with and overriding signal 208 at I/O pad 108 by changing its pre-programmed default or fixed logic level will trigger an assertion of exception 210, signaling a security violation. As with the I/O circuit 100A of FIG. 1A, exception signal 210 of I/O circuit 100C may also be used to trigger the isolation, reset or power-down of part or all of a system that includes a chip incorporating I/O circuit 100C, and such action may be initiated by hardware, software, or a combination of hardware and software monitoring and/or reacting to the assertion of exception signal 210.

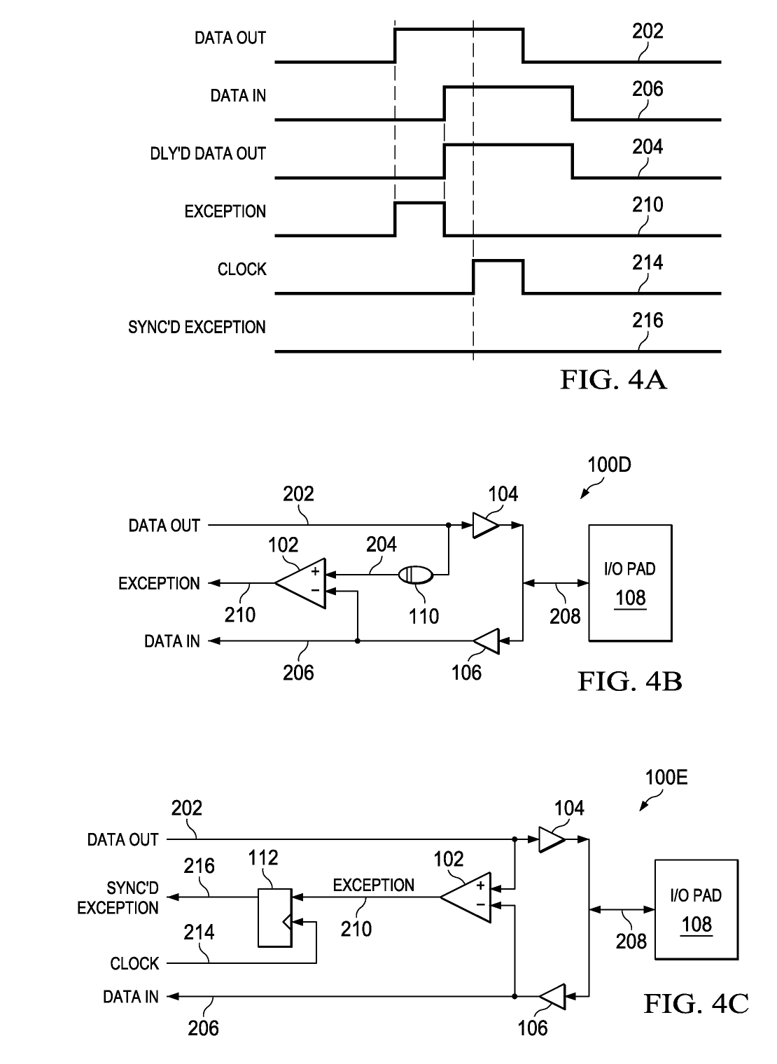

As previously noted, there is a finite propagation delay of data signal 202 of FIG. 1A, and likewise of pull-up enable signal 212 of FIG. 3, before the logic level of these signal is reflected by Data In signal 206 of both FIGS. 1A and 3, assuming no tampering and overriding of signal 208, present at I/O pad 108. The propagation delay may be increased even further by loading (e.g., capacitive loading) present at I/O pad 108 due to other external circuitry that is connected to the I/O pad, which can slow down the rise and fall times of signals present at the I/O pad. During this propagation time, it is possible for exception signal 210 to be asserted for short periods of time as shown in FIG. 4A, creating false exception pulses. FIGS. 4B and 4C illustrate examples of two alternative circuits for eliminating such pulses. In the illustrative embodiments of FIG. 4B, I/O circuit 100D includes a delay line 110 that delays Data Out signal 202 by a time comparable to the delay time introduced by output driver 104 and input buffer 106, as well as delays caused by slow signal rise and fall times that may result from loading present at I/O pad 108. As can be seen in FIG. 4A, this results in Delayed Data Out (Dly'd Data Out) signal 204, which transitions at or near the time of the transition of Data In signal 206 when there is no tampering. In the illustrative embodiment of FIG. 4C, clocked register 112 of I/O circuit 100E uses clock signal 214 to sample the output of comparator 102 after a time delay, equal to or greater than the time necessary for transitions of Data Out signal 202 to propagate to Data In signal 206, has elapsed (see FIGS. 4A and 4C). In yet another embodiment (not shown), the output of the comparator is disabled or kept de-asserted until after a delay time equal or greater than the propagation time of the Data Out signal through both the output driver and the input buffer. Other methods for eliminating false exception pulses will become apparent to those of ordinary skill in the art, and all such methods are within the scope of the present disclosure.

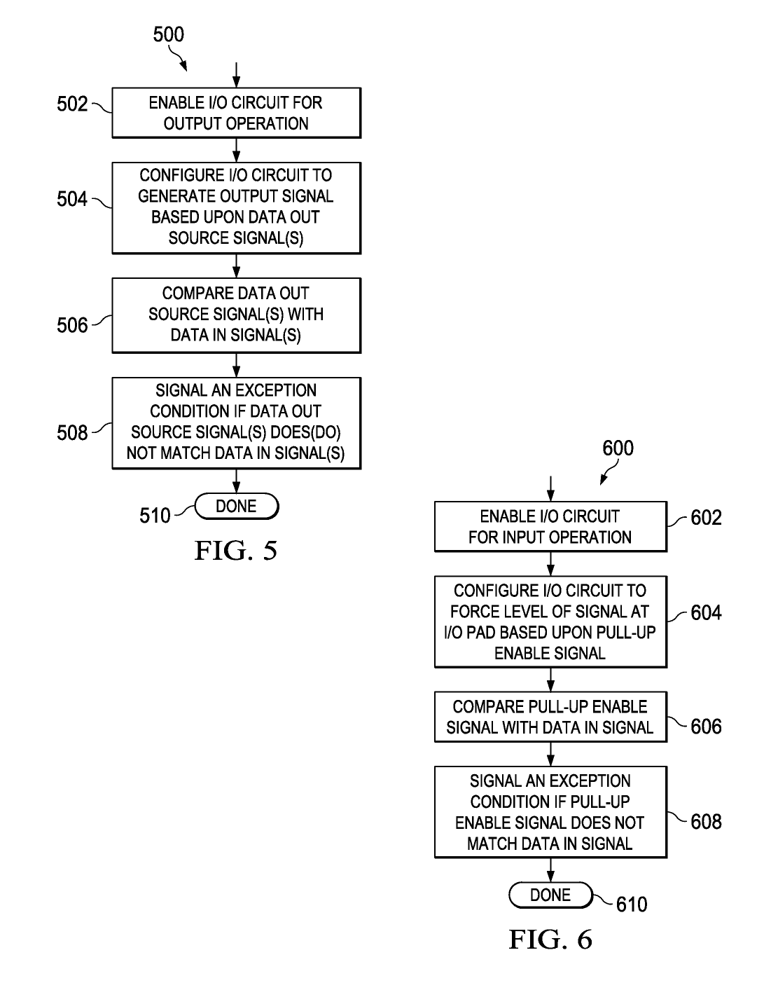

FIG. 5 illustrates a method 500 for detecting when an output signal at an I/O pin of a semiconductor chip has been tampered with. After the chip has been configured and enabled for output operation (block 502), the I/O circuit is configured to generate an output signal based upon a one or more Data Out source signals provided to the I/O circuit (block 504). One or more Data Out source signals are compared with one or more Data In signals that reflect the signal present at the I/O pin (block 506). The signal present at the I/O pin may be either a digital signal or an analog signal, as previously described. If the Data In signals do not match the corresponding Data Out source signals, an exception condition is signaled (block 508), indicating that the signal at the I/O pin has been tampered with and that a security violation has occurred, completing the method (block 510).

If the signal present at the I/O pin described in method 500 is a digital signal, the mismatch represents a difference in the logical level (a logical “0” or “1”) of the Data Out signal and the logical level of the Data In signal, which, in at least some illustrative embodiments, each function as a digital representation of a single bit value. If the signal present at the I/O pin is an analog signal, the mismatch represents a mismatch in at least some of the bits of the Data Out signal and at least some corresponding bits of the Data In signal. In such illustrative embodiments, the bits of the Data Out signal function as a digital representation of the analog signal levels driven, in the absence of tampering, by an output circuit onto the I/O pin. Similarly, the bits of the Data In signal function as a digital representation of the analog signal detected by an input circuit monitoring signal levels at the I/O pin.

FIG. 6 similarly illustrates a method 600 for detecting when an input signal at an I/O pin of a semiconductor chip, configured to a default or fixed level by internal pull-ups or pull-downs, has been tampered with. After the chip has been configured and enabled for input operation (block 602), the I/O circuit is configured to force the input signal at the I/O pad to a default or fixed logic level using either a pull-up or pull-down structure within the I/O circuit (block 604). The pull-up enable signal is compared with a Data In signal that reflects the signal present at the I/O pin (block 606). If the Data In signal does not match the pull-up enable signal, an exception condition is signaled (block 608), indicating that the signal at the I/O pin has been tampered with and that a security violation has occurred, completing the method (block 610).

The above disclosure is meant to be illustrative of the principles and various embodiments of the present invention. Numerous variations and modifications will become apparent to those skilled in the art once the above disclosure is fully appreciated. For example, at least some of the illustrative embodiments described and shown use complimentary metal-oxide semiconductor (CMOS) devices, but other illustrative embodiments may be implemented using other semiconductor technologies or combinations of technologies, such as PMOS (Positive-Channel MOS), NMOS (Negative-Channel MOS), and bipolar technologies, just to name a few. It is intended that the following claims be interpreted to embrace all such variations and modifications.

What is claimed is:

1. An integrated circuit, comprising:
an input/output (I/O) pad, electrically accessible from outside the integrated circuit;
an I/O circuit coupled to the I/O pad that receives an internally generated signal and causes the internally generated signal to be propagated to the I/O pad; and
a comparator having first and second input nodes, the first input node configured to receive a digital representation of the internally generated signal, and the second input node coupled to the I/O pad and configured to receive a digital representation of a signal present at the I/O pad;
wherein the comparator signals an exception condition if a logic level of a bit of the digital representation of the internally generated signal does not match a logic level of a bit of the digital representation of the signal present at the I/O pad.

2. The integrated circuit of claim 1, wherein the signal present at the I/O pad comprises a digital signal.

3. The integrated circuit of claim 1, wherein the signal present at the I/O pad comprises an analog signal, and wherein the bit of the digital representation comprises one of a plurality of digital bits that represent the value of the analog signal.

4. The integrated circuit of claim 1, the I/O circuit further comprising an output driver that, in the absence of an externally generated signal at the I/O pad, generates the signal present at the I/O pad when the I/O circuit is configured for output operation, wherein the internally generated signal is accepted at the input node of the output driver and determines a signal level present at the I/O pad.

5. The integrated circuit of claim 1, further comprising:
a programmable pull-up circuit coupled between a positive node of a power source and the I/O pad, and a programmable pull-down circuit coupled between a negative node of the power source and the I/O pad;
wherein the logic level of the bit of the digital representation of the internally generated signal determines which of either the programmable pull-up circuit or the programmable pull-down circuit is enabled; and
wherein an enabled programmable circuit determines a logic level of the signal presented at the I/O pad when the I/O circuit is configured for input operation, in the absence of an externally generated signal at the I/O pad.

6. The integrated circuit of claim 1, wherein the exception condition is indicative of a security violation.

7. The integrated circuit of claim 1, wherein the exception condition generates an interrupt to a processor, and wherein the interrupt triggers execution of exception processing software that runs on the processor.

8. The integrated circuit of claim 1, wherein the exception condition causes a shutdown of at least part of the integrated circuit.

9. The integrated circuit of claim 1, wherein the exception condition causes a reset of at least part of the integrated circuits.

10. The integrated circuit of claim 1, further comprising a delay line that comprises an output node coupled to the first input node of the comparator and an input node configured to accept the internally generated signal, wherein the delay line time delays the internally generated signal accepted at the first input node of the comparator.

11. An on-chip input/output (I/O) circuit, comprising:
a comparator having first and second input nodes, the first input node configured to receive a source signal, and the second input node coupled to an I/O pad and configured to receive a signal present at the I/O pad;
wherein the I/O circuit receives the source signal and causes the source signal to be propagated to the I/O pad; and
wherein an exception condition is signaled by the comparator if one or more logic levels of at least part of a digital representation of the source signal does not match one or more logic levels of at least a corresponding part of a digital representation of the signal present at the I/O pad.

12. The on-chip I/O circuit of claim 11, wherein the signal present at the I/O pad comprises a digital signal.

13. The on-chip I/O circuit of claim 11,
wherein the signal present at the I/O pad comprises an analog signal; and
wherein the digital representation of the source signal comprises a digital value associated with the analog value of the analog signal, in the absence of an externally generated signal at the I/O pad.

14. The on-chip I/O circuit of claim 11, further comprising an output driver that accepts the source signal as an input that, in the absence of an externally generated signal at the I/O pad, determines the level of the signal at the I/O pad, when the I/O circuit is configured for output operation.

15. The on-chip I/O circuit of claim 11, further comprising:
a programmable pull-up circuit coupled between a positive node of a power source and the I/O pad, and a programmable pull-down circuit coupled between a negative node of the power source and the I/O pad;
wherein the logic level of a bit of the digital representation of the source signal determines which of either the programmable pull-up circuit or the programmable pull-down circuit is enabled; and
wherein an enabled programmable circuit determines the logic level of the signal presented at the I/O pad when the I/O circuit is configured for input operation, in the absence of an externally generated signal at the I/O pad.

16. The on-chip I/O circuit of claim 11, wherein the exception condition is indicative of a security violation.

17. The on-chip I/O circuit of claim 11, further comprising a clocked register that comprises an input node that is coupled to an output node of the comparator, wherein a clock signal causes an exception signal present at the output node of the comparator to be sampled and stored in the clocked register, and wherein the exception signal is sampled after a time delay equal or greater that the time required for a transition of at least part of the source signal to propagate to the second input node of the comparator.

18. A method, comprising:
enabling an input/output (I/O) circuit to determine a level of a signal present at an I/O pad based upon a control signal;
comparing one or more bits of a digital representation of the control signal to one or more bits of a digital representation of the signal present at the I/O pad; and
signaling an exception if a logic level of at least one of the one or more bits of the digital representation of the control signal does not match a level of at least one of the one or more corresponding bits of the digital representation of the signal present at the I/O pad.

19. The method of claim 18, wherein the signal present at the I/O pad comprises a digital signal.

20. The method of claim 18, wherein enabling the I/O circuit to determine the logic level of the signal present at the I/O pad comprises driving an output driver with the control signal to produce at the output node of the output driver the signal present at the I/O pad, in the absence of an overriding signal being driven onto the I/O pad.

21. The method of claim 18, wherein enabling the I/O circuit to determine a logic level of a signal present at an I/O pad comprises:
using the control signal to enable either a selectable pull-up circuit that causes the signal present at the I/O pad to be driven to a first voltage level, or a selectable pull-down circuit that causes the signal present at the I/O pad to be drive to a second voltage level lower that the first voltage level; and
an enabled selectable device determining the logic level of the signal present at the I/O pad in the absence of an overriding signal being driven onto the I/O pad.

22. The method of claim 18, further comprising shutting down a system comprising the I/O circuit if the exception is signaled.

23. The method of claim 18, further comprising resetting a system comprising the I/O circuit if the exception is signaled.

24. The method of claim 18, further comprising generating an interrupt to a processor if the exception is signaled.

25. The method of claim 18, wherein signaling an exception comprises signaling a security violation.
